(19) United States
(12) Patent Application Publication
(10) Pub. No.: US 2026/0051491 A1
(43) Pub. Date: Feb. 19, 2026

(54) ELECTRODE ACTIVE MATERIAL, BATTERY, AND MANUFACTURING METHOD OF ELECTRODE ACTIVE MATERIAL

(71) Applicant: Toyota Jidosha Kabushiki Kaisha, Toyota-shi (JP)

(72) Inventor: Shohei KAWASHIMA, Susono-shi (JP)

(73) Assignee: TOYOTA JIDOSHA KABUSHIKI KAISHA, Toyota-shi (JP)

(21) Appl. No.: 19/203,655

(22) Filed: May 9, 2025

(30) Foreign Application Priority Data
Aug. 13, 2024 (JP) 2024-135014

(51) Int. Cl. H01M 4/525; H01M 4/02; H01M 4/04; H01M 4/505

(52) U.S. Cl. CPC H01M 4/525; H01M 4/049; H01M 4/505; H01M 2004/021

(57) ABSTRACT

The present application discloses an electrode active material, a battery, and a manufacturing method of an electrode active material. The electrode active material of the disclosure is characterized in that, in an X-ray diffraction pattern thereof, a half-value width of a diffraction peak among diffraction peaks attributable to an O2-type structure that has a peak top at 2θ=64.8° to 65.4° is less than 0.79°.

### CROSS-REFERENCE TO RELATED APPLICATION

This application claims priority to Japanese Patent Application No. 2024-135014 filed on Aug. 13, 2024. The disclosure of the above-identified application, including the specification, drawings, and claims, is incorporated by reference herein in its entirety.

### BACKGROUND

### 1. Technical Field

The present application discloses an electrode active material, a battery, and a manufacturing method of an electrode active material.

### 2. Description of Related Art

An electrode active material having an O2-type structure (O: Octahedral) is known. As disclosed in Japanese Unexamined Patent Application Publication No. 2010-092824 (JP 2010-092824 A), an electrode active material having the O2-type structure is obtained by exchanging at least some of Na ions of an Na-containing transition metal oxide having a P2-type structure with Li ions.

### SUMMARY

Conventional electrode active materials having the O2-type structure have room for improvement in terms of achieving both a high capacity and low resistance.

The present application discloses the following aspects as means for solving the above challenge:

### Aspect 1

An electrode active material having an O2-type structure, wherein, in an X-ray diffraction pattern of the electrode active material, a half-value width of a diffraction peak among diffraction peaks attributable to the O2-type structure that has a peak top at 2θ=64.8° to 65.4° is less than 0.79°.

### Aspect 2

The electrode active material according to Aspect 1, wherein the half-value width may be 0.66° or less.

### Aspect 3

The electrode active material according to Aspect 1 or 2, wherein the electrode active material may have a chemical composition represented by LiₐNa_{b}Mnₓ₋ₚNi_{y-q}CO_{z-r}M_{p+q+r}O₂ (where 0.70<a≤1.40, 0≤b≤0.20, x+y+z=1, 0≤p+q+r<0.17, and M is at least one type of element selected from B, Mg, Al, K, Ca, Ti, V, Cr, Fe, Cu, Zn, Ga, Ge, Sr, Y, Zr, Nb, Mo, and W).

### Aspect 4

A battery may have the electrode active material according to any one of Aspects 1 to 3.

### Aspect 5

A manufacturing method of an electrode active material, including:
obtaining an Na-containing transition metal oxide having a P2 structure;
exchanging at least some of Na of the Na-containing transition metal oxide with Li by ion exchange to obtain an Li-containing transition metal oxide having an O2-type structure; and
bringing a reducing solution containing Li ions into contact with the Li-containing transition metal oxide to dope the Li-containing transition metal oxide with Li, wherein:
a time for which the reducing solution is held in contact with the Li-containing transition metal oxide is 10 minutes or longer and 120 minutes or shorter; and
a temperature at which the reducing solution is held in contact with the Li-containing transition metal oxide is 10° C. or higher and 50° C. or lower.

The electrode active material of the present disclosure has the O2-type structure and is likely to achieve both a high capacity and low resistance.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 shows one example of a flow of a manufacturing method of an electrode active material;

FIG. 2 schematically shows one example of the configuration of a battery;

FIG. 3 shows X-ray diffraction patterns of electrode active materials respectively of Example 1, Comparative Example 1, and Comparative Example 3; and

FIG. 4 shows a relationship between a half-value width of an X-ray diffraction peak and a normalized resistance value.

### DETAILED DESCRIPTION OF EMBODIMENTS

### 1. Electrode Active Material

An electrode active material according to one embodiment has an O2-type structure. In an X-ray diffraction pattern of the electrode active material, a half-value width of a diffraction peak among diffraction peaks attributable to the O2-type structure that has a peak top at 2θ=64.8° to 65.4° is less than 0.79°.

### 1.1 Crystal Structure

The electrode active material has the O2-type structure (which belongs to space group P63mc). In addition to the O2-type structure, the electrode active material may have other crystal structures. For example, the electrode active material may have one or both of a T #2-type structure (which belongs to space group Cmca) and an O6-type structure (which belongs to space group R-3m and has a c-axis length of 2.5 nm or longer and 3.5 nm or shorter, typically 2.9 nm or longer and 3.0 nm or shorter, and which is different from an O3-type structure that also belongs to space group R-3m). The electrode active material may have the O2-type structure as a main phase or may have a crystal structure other than the O2-type structure as a main phase. In particular, having the O2-type structure as a main phase is preferable.

When an X-ray diffraction pattern of the electrode active material according to the embodiment is acquired, this X-ray diffraction pattern includes diffraction peaks attributable to the above-described O2-type structure. One feature of the embodiment is that a half-value width of a diffraction peak among the diffraction peaks attributable to the O2-type structure that has a peak top at 2θ=64.8° to 65.4° is less than 0.79°.

That there is a diffraction peak in the X-ray diffraction pattern of the electrode active material that is attributable to the O2-type structure and has a peak top at 2θ=64.8° to 65.4° means that an Li deficiency in this electrode active material is small and that a large amount of Li is contained in the crystal structure of this electrode active material. This is to be described more specifically as follows. First, among the diffraction peaks attributable to the O2-type structure, the diffraction peak having a peak top at 2θ=64.8° to 65.4° is considered to correspond to, for example, a diffraction peak attributable to (110) plane of the O2-type structure. Here, the X-ray diffraction peak attributable to (110) plane of the O2-type structure shifts in proportion to the amount of Li in the electrode active material. Specifically, the X-ray diffraction peak attributable to (110) plane of the O2-type structure has a peak top near 2θ=65° when the molar ratio of Li contained in the electrode active material (“a” in a chemical composition to be described later) is 1.0.

As will be described later, in a conventional method, the molar ratio of Li contained in an electrode active material having the O2-type structure (“a” in the chemical composition to be described later) is no more than 0.7 or lower, and thus the capacity potential of the electrode active material fails to be fully exploited. By contrast, in the embodiment, since a diffraction peak that is attributable to the O2-type structure and has a peak top at 2θ=64.8° to 65.4° is present in the X-ray diffraction pattern of the electrode active material, it can be said that a large amount of Li has been inserted in the electrode active material and that the molar ratio of Li contained in the electrode active material (“a” in the chemical composition to be described later) has been increased to above 0.7 (e.g., near 1.0). Thus, the capacity of the electrode active material having the O2-type structure is likely to increase.

On the other hand, when the state of insertion of Li in the O2-type structure becomes non-uniform, excessive insertion of Li is likely to occur, so that, for example, Li is likely to be inserted to a position not between layers of the O2-type structure, which is likely to result in higher resistance. Here, when the state of insertion of Li in the O2-type structure becomes non-uniform, the aforementioned diffraction peak having a peak top at 2θ=64.8° to 65.4° broadens and the half-value width thereof becomes larger. By contrast, in the embodiment, the half-value width of the diffraction peak among the diffraction peaks attributable to the O2-type structure that has a peak top at 2θ=64.8° to 65.4° is as small as less than 0.79°. Thus, in the electrode active material according to the embodiment, the uniformity of the state of insertion of Li in the O2-type structure is high, and Li is less likely to be inserted to a position not between layers of the O2-type structure, so that the electrode active material is likely to have low resistance. In particular, when the half-value width is 0.66° or less, the resistance can be more significantly reduced. The lower limit value of the half-value width is not particularly limited. The half-value width may be, for example, 0.58° or more, 0.60° or more, or 0.62° or more.

In the present application, “X-ray diffraction pattern” and “half-value width of diffraction peak” refer to those acquired under the following conditions: Using an X-ray diffractometer (Rigaku Corporation, a fully automatic multipurpose X-ray diffractometer “SmartLab”), with CuKα as the radiation source, the X-ray diffraction pattern is acquired by performing 2θ/θ scanning on the electrode active material at a tube voltage of 45 kV, a tube current of 200 mA, a step width of 0.02° and a scanning speed of 1°/min. In this X-ray diffraction pattern, a diffraction peak that is attributable to the O2-type structure and has a peak top at 2θ=64.8° to 65.4° is determined, and after the value of a background near this diffraction peak is subtracted, the half-value width of this diffraction peak is determined.

In the electrode active material according to one embodiment, the crystallite size of the above-described O2-type structure is not particularly limited. In the electrode active material according to one embodiment, one crystallite may form one particle alone, or a plurality of crystallites may form one particle. In other words, the electrode active material according to one embodiment (1) may be a single-crystal particle that is present independently; (2) may be an aggregate (secondary particle) of a plurality of single-crystal particles; (3) may be a polycrystalline particle including a plurality of crystallites; or (4) may be an aggregate (secondary particle) of a plurality of polycrystalline particles. In particular, when the electrode active material is a polycrystalline particle, especially when it is a spherical polycrystalline particle to be described later, even higher performance of the electrode active material is likely to be secured. As will be described later, the electrode active material according to one embodiment can be obtained by going through ion exchange of at least some of Na of an Na-containing oxide having a P2-type structure with Li. Here, the P2-type structure is a hexagonal system, in which the diffusion coefficient of Na ions is high and crystals are likely to grow in a specific direction. Therefore, crystallites having the P2-type structure are usually ones of which the crystal growth direction is disproportionately one specific direction (e.g., plate-shaped ones). When crystallites of the O2-type structure are obtained by exchanging Na ions of the P2-type crystallites of which the crystal growth direction is thus disproportionately one specific direction with Li ions, end portions of the crystallites of the O2-type structure (end portions in the aforementioned crystal growth direction) are likely to constitute inlets and outlets for intercalation. In other words, when the electrode active material is a polycrystalline particle, effects can be expected such as an effect that the reaction resistance decreases as the numbers of inlets and outlets for intercalation included in one particle increase, an effect that the diffusion resistance decreases as the travel distance of lithium ions becomes shorter, and an effect that the amount of expansion and contraction of particles as a whole during charging and discharging becomes smaller.

As described above, the crystallites of the Na-containing oxide having the P2-type structure are likely to assume a plate shape. That is, the Na-containing oxide having the P2-type structure can become a plate-shaped particle, as well as can become a spherical particle as small plate-shaped crystallites couple to one another. In other words, one electrode active material particle as a whole may be a plate-shaped single-crystal particle or may be a spherical polycrystalline particle. Aspherical polycrystalline particle has a plurality of crystallites in its surface. When the electrode active material is a spherical polycrystalline particle, the degree of flexion is reduced owing to its spherical shape, which seems to reduce the lithium-ion conduction resistance. Thus, for example, it is likely that the battery has improved rate characteristics and a higher reversible capacity. In the present application, “spherical particle” means a particle of which the degree of circularity is 0.80 or higher. The degree of circularity of the particle may be 0.81 or higher, 0.82 or higher, 0.83 or higher, 0.84 or higher, 0.85 or higher, 0.86 or higher, 0.87 or higher, 0.88 or higher, 0.89 or higher, or 0.90 or higher. The degree of circularity of the particle is defined by 4πS/L². Here, S is an orthographic projection area of the particle, and Lis a perimeter of an orthographic projection image of the particle. The degree of circularity of the particle can be obtained by observing the appearance of the particle under a scanning electron microscope (SEM), a transmission electron microscope (TEM), or an optical microscope.

### 1.2 Chemical Composition

The chemical composition of the electrode active material is not particularly limited as long as the above-described O2-type structure can be maintained and the above-described requirements regarding the half-value width are met. The electrode active material may contain at least, as its constituent elements, at least one type of element selected from Mn, Ni, and Co, Li, and O. In particular, when at least, as constituent elements, Mn, at least one of Ni and Co, Li, and O are contained, especially when at least, as constituent elements, Li, Mn, Ni, Co, and O are contained, even higher performance is likely to be secured. However, when Li is almost completely released by charging, for example, the molar concentration of Li in the electrode active material can approach zero to the utmost limit. The electrode active material can contain Na as its constituent element due to a manufacturing step to be described later. The electrode active material can contain a predetermined element M. The electrode active material can contain other impurity elements. For example, the electrode active material can contain, as impurities, components due to the manufacturing step to be described later. Specifically, the electrode active material may contain components (an aromatic compound, ether, etc.) attributable to a reducing solution.

The electrode active material according to one embodiment may have a chemical composition represented by LiₐNa_{b}Mnₓ₋ₚNi_{y-q}Co₂₋ᵣM_{p+q+r}O₂ (where 0.70<a≤1.40, 0≤b≤0.20, x+y+z=1, 0≤p+q+r<0.17, and M is at least one type of element selected from B, Mg, Al, K, Ca, Ti, V, Cr, Fe, Cu, Zn, Ga, Ge, Sr, Y, Zr, Nb, Mo, and W). In this chemical composition, a exceeds 0.70 and may be 0.75 or more, 0.80 or more, 0.85 or more, 0.90 or more, or 0.95 or more, and is 1.40 or less and may be 1.35 or less, 1.30 or less, 1.25 or less, 1.20 or less, 1.15 or less, 1.10 or less, 1.05 or less, or 1.00 or less. The composition ratio of b is 0 or more and may exceed 0, and is 0.20 or less and may be 0.15 or less, 0.10 or less, 0.05 or less, 0.04 or less, 0.03 or less, 0.02 or less, or 0.01 or less. The composition ratio of x is 0 or more and may be 0.10 or more, 0.20 or more, 0.30 or more, 0.40 or more, or 0.50 or more, and is 1.00 or less and may be 0.90 or less, 0.80 or less, 0.70 or less, 0.60 or less, or 0.50 or less. The composition ratio of y is 0 or more and may be 0.10 or more or 0.20 or more, and is 1.00 or less and may be 0.90 or less, 0.80 or less, 0.70 or less, 0.60 or less, 0.50 or less, 0.40 or less, 0.30 or less, or 0.20 or less. The composition ratio of z is 0 or more and may be 0.10 or more, 0.20 or more, or 0.30 or more, and is 1.00 or less and may be 0.90 or less, 0.80 or less, 0.70 or less, 0.60 or less, 0.50 or less, 0.40 or less, or 0.30 or less. The element M contributes a little to charging and discharging. In this respect, when p+q+r is less than 0.17 in the above-described chemical composition, a high charge-discharge capacity is likely to be secured. The composition ratio of p+q+r may be 0.15 or less, 0.13 or less, 0.11 or less, 0.09 or less, 0.07 or less, 0.06 or less, 0.05 or less, or 0.04 or less. On the other hand, when the element M is contained, the O2-type structure is likely to stabilize. In this respect, in the above-described chemical composition, p+q+r is 0 or more, and may exceed 0 or be 0.01 or more, 0.02 or more, or 0.03 or more. While the composition ratio of 0 is almost 2, it is not limited to being exactly 2.0 and is variable. In the above-described chemical composition, when the valence of the element M is +n, a relationship 3.0≤4 (x−p)+2 (y−q)+3 (z−r)+n(p+q+r)≤3.5 may be met. This is intended as a range in which the total valence of metal in an Li-containing transition metal oxide is near 3.33 valence (charge neutral when “a” is 0.67). During its synthesis, an Li-containing transition metal oxide having the O2-type structure goes through a state of an Na-containing transition metal oxide having the P2-type structure. A case where the above relationship is met corresponds to a case where charge neutral is reached in a range where the Na composition ratio in that state is 0.5 or more and 1.0 or less.

### 1.3 Others

The electrode active material according to one embodiment may be, for example, solid particles, hollow particles, or particles with voids. While the size of the particles of the electrode active material is not particularly limited, a smaller size is considered to be more advantageous. For example, an average particle diameter (D50) of the particles of the electrode active material may be 0.1 μm or larger and 10 μm or smaller, 1.0 μm or larger and 8.0 μm or smaller, or 2.0 μm or larger and 6.0 μm or smaller. The average particle diameter (D50) is a particle diameter (D50, a median diameter) at an integrated value of 50% in a volume-based particle size distribution obtained by a laser diffraction scattering method. The electrode active material according to one embodiment may be a positive electrode active material.

### 2. Manufacturing Method of Electrode Active Material

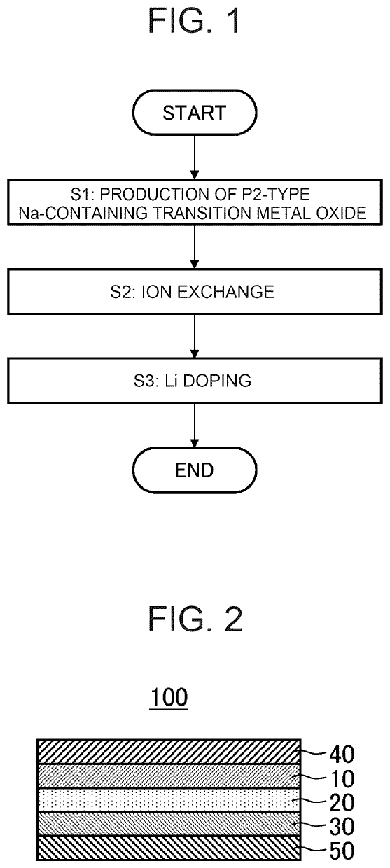

As shown in FIG. 1, a manufacturing method of an electrode active material according to one embodiment includes:
obtaining an Na-containing transition metal oxide having a P2-type structure (step S1);
exchanging at least some of Na of the Na-containing transition metal oxide with Li by ion exchange to obtain an Li-containing transition metal oxide having an O2-type structure (step S2); and
bringing a reducing solution containing Li ions into contact with the Li-containing transition metal oxide to dope the Li-containing transition metal oxide with Li (step S3).

Here, the above-described electrode active material according to one embodiment can be manufactured by controlling a contact time and a contact temperature in step S3. For example, in the manufacturing method of an electrode active material according to one embodiment,
a time for which the reducing solution is held in contact with the Li-containing transition metal oxide may be 10 minutes or longer and 120 minutes or shorter; and
a temperature at which the reducing solution is held in contact with the Li-containing transition metal oxide may be 10° C. or higher and 50° C. or lower.

### 3.1 Step S1

In step S1, the Na-containing transition metal oxide having the P2-type structure can be obtained by, for example, after obtaining a precursor containing Na and a transition metal element, optionally shaping this precursor and optionally performing preliminary firing and then performing main firing.

In step S1, the precursor may be obtained by, for example, mixing a transition metal source and an Na source together. The transition metal source may be, for example, transition metal salt, such as carbonate, sulfate, nitrate, or acetate, or may be a transition metal compound, such as transition metal hydroxide. The transition metal element may be at least one of Mn, Ni, and Co. The transition metal source may be salt represented by Me(CO₃)ₓ (Me is at least one transition metal element among Mn, Ni, and Co, and x depends on the valence of Me), or may be salt represented by Me(SO₄)ₓ, or may be salt represented by Me(NO₃)ₓ, or may be salt represented by Me(CH₃COO)ₓ, or may be a compound represented by Me(OH)ₓ. The Na source may be, for example, Na salt, such as carbonate or sulfate, or may be an Na compound, such as sodium oxide or sodium hydroxide. The amount of Na source to be mixed relative to the transition metal source may be determined taking into account the amount of Na to be lost during the subsequent firing. In step S1, a surface of the particle formed by the above-described transition metal source may be coated with the Na source to obtain a coated particle as the precursor. Here, the coated particle may be obtained by coating at least part of the surface of the particle formed by the above-described transition metal source with the Na source. The coated particle may be obtained by coating 40 area % or more, 50 area % or more, 60 area % or more, or 70 area % or more of the surface of the particle formed by the above-described transition metal source with the Na source.

In step S1, the precursor may be obtained by, for example, mixing an M source containing the element M in addition to the transition metal source and the Na source. Here, the element M is at least one type selected from B, Mg, Al, K, Ca, Ti, V, Cr, Fe, Cu, Zn, Ga, Ge, Sr, Y, Zr, Nb, Mo, and W. The element M can further stabilize the P2-type structure and the O2-type structure. The M source may be, for example, salt, such as nitrate, sulfate, carbonate, or acetate, or may be a compound other than salt, such as hydroxide. The amount of M source in the precursor can be determined as appropriate according to the target composition of the Na-containing transition metal oxide after firing.

In step S1, the precursor may be obtained by, for example, after obtaining a precipitate using a transition metal compound and an ion source that can form a precipitate with a transition metal ion in an aqueous solution, and then mixing this precipitate, an Na source, and optionally an element M source together. Examples of ion sources that can form a precipitate with a transition metal ion include sodium salt, such as sodium carbonate and sodium nitrate, sodium hydroxide, and sodium oxide. Examples of transition metal compounds include salt, such as nitrate, sulfate, carbonate, and acetate, and hydroxide. In step S1, a precipitate may be obtained by turning each of the ion source and the transition metal compound into a solution and then dripping and mixing together these solutions. In this case, various sodium compounds may be used as a base, and an ammonia aqueous solution or the like may be added to adjust the basicity. More specifically, in step S1, as a precipitate, one containing at least one transition metal element among Mn, Ni, and Co may be obtained. The precipitate can be obtained by, for example, a solution method, such as a coprecipitation method or a sol-gel method. In the case of the coprecipitation method, a precipitate can be obtained by, for example, preparing an aqueous solution of Me(SO₄)ₓ and an aqueous solution of Na₂CO₃ and dripping and mixing together these aqueous solutions. After collecting the precipitate, this precipitate and an Na source may be mixed together. The amount of Na source to be mixed relative to the precipitate may be determined taking into account the amount of Na to be lost during the subsequent firing. A surface of a particle formed by the precipitate may be coated with Na salt to obtain a coated particle as the precursor. The coating ratio etc. for the coating particle are as described above.

In step S1, the preliminary firing of the precursor obtained as described above can be performed at a temperature equal to or lower than that of the main firing. For example, the preliminary firing can be performed at a temperature lower than 700° C. The preliminary firing time is not particularly limited. Or the preliminary firing may be omitted.

In step S1, the main firing of the precursor may be performed at a temperature of, for example, 700° C. or higher and 1100° C. or lower. The temperature is preferably 800° C. or higher and 1000° C. or lower. When the main firing temperature is too low, Na doping fails to be performed, and when the main firing temperature is too high, a structure other than the P2-type structure is likely to form. The temperature raising condition from the preliminary firing temperature to the main firing temperature is not particularly limited. The main firing time is not particularly limited, either, and may be, for example, 30 minutes or longer and 10 hours or shorter. The main firing atmosphere is not particularly limited, either, and may be, for example, an oxygen-containing atmosphere, such as an ambient air atmosphere, or an inert gas atmosphere.

In step S1, after the above-described main firing, the Na-containing transition metal oxide having the P2-type structure may be doped with the above-described element M. That is, after an Na-containing transition metal oxide having the P2-type structure that does not contain the element M is synthesized, this oxide may be doped with the element M. Doping of the element M may be performed by, for example, ion exchange.

The Na-containing transition metal oxide obtained by step S1 may contain at least, as its constituent elements, for example, at least one type of element among Mn, Ni, and Co, Na, and O. In particular, when at least, as constituent elements, Na, Mn, at least one of Ni and Co, and O are contained, especially when at least, as constituent elements, Na, Mn, Ni, Co, and O are contained, the performance of the positive electrode active material is likely to be even higher. More specifically, the Na-containing transition metal oxide obtained by step S1 may have a chemical composition represented by Na_{c}Mnₓ₋ₚNi_{y-q}Co_{z-r}M_{p+q+r}O₂ (where 0<c≤1.00, x+y+z=1, and 0≤p+q+r<0.17, and the element M is at least one type selected from B, Mg, Al, K, Ca, Ti, V, Cr, Fe, Cu, Zn, Ga, Ge, Sr, Y, Zr, Nb, Mo, and W). When the Na-containing transition metal oxide has such a chemical composition, the P2-type structure is likely to be maintained. In the above chemical composition, c exceeds 0 and may be 0.10 or more, 0.20 or more, 0.30 or more, 0.40 or more, 0.50 or more, or 0.60 or more, and is 1.00 or less and may be 0.90 or less, 0.80 or less, or 0.70 or less. The composition ratios of x, y, z, p, q, and r as well as O may be the same as those mentioned above, and description thereof is omitted here.

### 2.2 Step S2

In step S2, at least some of Na of the Na-containing transition metal oxide obtained by step S1 are exchanged with Li by ion exchange to obtain an Li-containing transition metal oxide having the O2-type structure. In step S2, at least some of Na of the Na-containing transition metal oxide can be exchanged with Li by, for example, ion exchange using lithium salt. For example, at least some of Na can be exchanged with Li by ion exchange by, for example, mixing the Na-containing transition metal oxide having the P2-type structure and lithium salt together and then heating the mixture to a temperature equal to or higher than the melting point of the lithium salt so as to melt the lithium salt. The lithium salt may be, for example, lithium halide. The lithium halide is preferably at least one of lithium chloride, lithium bromide, and lithium iodide. Or the lithium salt may be lithium nitrate. Or the lithium salt may be mixed salt of lithium halide and lithium nitrate.

In step S2, the element M may be doped during the above-described ion exchange. The above-described Na-containing transition metal oxide can be doped with the element M by, for example, heating and melting salt containing the element M and then bringing this salt into contact with the oxide. One example of salt containing the element M is halide of the element M. In step S2, salt containing Li and the element M may be brought into contact with the above-described Na-containing transition metal oxide to thereby perform ion exchange of at least some of Na of the Na-containing transition metal oxide particles with Li and dope the element M. When salt containing Li and the element M (mixed salt of lithium salt and the element M or composite salt of Li and the element M) is used, the melting point of salt can become lower than when lithium salt and salt of the element M are each independently used. In particular, when salt containing at least one of Al and Ga as the element M and Li is used, the melting point is likely to become significantly lower. Thus, the temperature required for melting becomes lower, so that the above-described ion exchange of Li and doping of the element M can be performed at low temperatures. The mixing ratio of lithium salt and salt of the element M is not particularly limited. Specific examples of salt containing Li and the element M include, for example, salt containing Li, the element M, and halogen (mixed salt of lithium halide and halide of the element M, or composite halide of Li and the element M).

The temperature in step S2 (e.g., the heating temperature in the case where lithium salt is brought into contact with the Na-containing transition metal oxide particles and then ion exchange is performed by heating and melting) may be, for example, 600° C. or lower, 500° C. or lower, 400° C. or lower, 350° C. or lower, 300° C. or lower, 280° C. or lower, 250° C. or lower, 230° C. or lower, 2θ0° C. or lower, 170° C. or lower, or 150° C. or lower, and may be room temperature or higher or 100° C. or higher. When the temperature is too high, instead of the O2-type structure, an O3-type structure that is a stable phase is likely to form. When melting the lithium salt, the lithium salt should be heated to or above its melting point as described above. The time in step S2 (e.g., the heating time in the case where lithium salt is brought into contact with the Na-containing transition metal oxide and then ion exchange is performed by heating and melting) may be adjusted such that a large portion of Na of the Na-containing transition metal oxide particles is exchanged with Li. From a viewpoint such as securing a sufficient time for the lithium salt to melt, the time in step S2 may be, for example, 10 minutes or longer or 60 minutes or longer, and may be 12 hours or shorter or six hours or shorter. The atmosphere in step S2 is not particularly limited, and may be, for example, an oxygen-containing atmosphere, such as an ambient air atmosphere, or an inert gas atmosphere. After the ion exchange, some kind of post-treatment, such as washing, may be performed on the Li-containing transition metal oxide having the O2-type structure.

In step S2, the O2-type Li-containing transition metal oxide obtained by the ion exchange may contain at least, as its constituent elements, at least one type of element selected from Mn, Ni, and Co, Li, and O. In particular, when at least, as constituent elements, Mn, at least one of Ni and Co, Li, and O are contained, especially when at least, as constituent elements, Li, Mn, Ni, Co, and O are contained, even higher performance is likely to be secured. The O2-type Li-containing transition metal oxide obtained by the ion exchange can contain Na as its constituent element due to the above-described manufacturing step. The O2-type Li-containing transition metal oxide obtained by the ion exchange can contain the above-described element M. The O2-type Li-containing transition metal oxide obtained by the ion exchange can contain other impurity elements. The chemical composition of the O2-type Li-containing transition metal oxide obtained by the ion exchange in step S2 may be represented by LiₐNa_{b}Mnₓ₋ₚNi_{y-q}Co_{z-r}M_{p+q+r}O₂ (where 0<a≤0.70, 0≤b≤0.20, x+y+z=1, and 0≤p+q+r<0.17, and the element M is at least one type selected from B, Mg, Al, K, Ca, Ti, V, Cr, Fe, Cu, Zn, Ga, Ge, Sr, Y, Zr, Nb, Mo, and W). In this chemical composition, a exceeds 0 and may be 0.10 or more, 0.20 or more, 0.30 or more, 0.40 or more, 0.50 or more, or 0.60 or more. The composition ratio of b is 0 or more and may exceed 0, and is 0.20 or less and may be 0.15 or less, 0.10 or less, 0.05 or less, 0.04 or less, 0.03 or less, 0.02 or less, or 0.01 or less. The composition ratios of x, y, z, p, q, and r as well as O may be the same as those mentioned above, and description thereof is omitted here.

### 3.3 Step S3

By going through steps S1 and S2 described above, an Li-containing transition metal oxide having the O2-type structure can be obtained. However, as far as the present inventor confirmed, when merely steps S1 and S2 described above are gone through, the amount of Li contained in the Li-containing transition metal oxide is little likely to be sufficient, and an electrode active material meeting the above-described requirements about the peak top position and the half-value width cannot be obtained. For example, by the above-described ion exchange, the molar ratio of Li in the Li-containing transition metal oxide (“a” described above) becomes no more than 0.70 or lower, and thus the potential of the capacity of the O2-type positive electrode active material cannot be fully exploited.

As a countermeasure, in step S3, the Li-containing transition metal oxide obtained by step S2 described above is additionally doped with Li in a separate step from the ion exchange to thereby increase the molar ratio of Li in the Li-containing transition metal oxide (“a” described above) to above 0.70. Specifically, in step S3, a reducing solution containing Li ions is brought into contact with the Li-containing transition metal oxide to thereby additionally dope the Li-containing transition metal oxide with Li in a separate step from the ion exchange. “Reducing solution” means a solution having reducing properties, and may be, for example, a solution containing an electrophile. The reducing solution may be obtained by, for example, dissolving an electrophile and an Li source in a solvent. As the solvent, various organic solvents that can dissolve an electrophile and an Li source can be adopted.

The solvent constituting the reducing solution may be, for example, ether. In other words, the reducing solution may contain ether. The ether is preferably, for example, at least one type selected from tetrahydrofuran that may have a substituent (tetrahydrofuran, 2-methyltetrahydrofuran, etc.), dialkyl ether (dibutyl ether etc.), alkylene glycol dialkyl ether (dimethoxyethane etc.), etc.

As the electrophile, various substances that dissolve in the above-described solvent can be adopted. The electrophile contained in the reducing solution may be, for example, an aromatic compound. In other words, the reducing solution may contain an aromatic compound. Here, when this aromatic compound has a plurality of benzene rings, the electron density inside the structure decreases and electrons inserted in the structure of the aromatic compound stabilize, so that higher effects can be expected. When this aromatic compound has an electron attracting group as a substituent, electrons are attracted by this electron attracting group, the electron density inside the benzene ring decreases, and the electrons inserted in the structure of the aromatic compound stabilize, so that higher effects can be expected. “Electron attracting group” refers to a group with a relatively high electronegativity that is a group including halogen, oxygen, and/or nitrogen. Specifically, the electron attracting group may be at least one type selected from a halogen group, a carbonyl group, a nitro group, etc. The aromatic compound as the electrophile is preferably, for example, at least one type selected from biphenyl that may have a substituent (e.g., biphenyl, 2-methylbiphenyl, etc.), fluorenone that may have a substituent(e.g., 9-fluorenone etc.), naphthalene that may have a substituent (e.g., naphthalene, fluoronaphthalene, bromonaphthalene, nitronaphthalene, etc.), anthracene that may have a substituent (e.g., anthracene, 9-bromoanthracene, etc.), tetracene that may have a substituent, pentacene that may have a substituent, tetraphenylcyclopentadienone that may have a substituent, etc.

As the Li source, various substances that dissolve in the above-described solvent and form Li ions can be adopted. The Li source may be metal lithium or may be an Li compound.

The concentrations of the electrophile and the Li ions contained in the reducing solution can be determined as appropriate according to the target doping amount. For example, when immersing the above-described Li-containing transition metal oxide in the reducing solution, the molar ratio between the Li ions contained in the reducing solution and the Li-containing transition metal oxide to be immersed in this reducing solution (Li ions/Li-containing transition metal oxide) may be 0.1 or higher, 0.2 or higher, 0.3 or higher, 0.4 or higher, 0.5 or higher, 0.6 or higher, 0.7 or higher, or 0.8 or higher, and may be 2.0 or lower, 1.5 or lower, 1.0 or lower, 0.9 or lower, 0.8 or lower, 0.7 or lower, 0.6 or lower, 0.5 or lower, 0.4 or lower, 0.3 or lower, or 0.2 or lower. In particular, when this molar ratio (Li ions/Li-containing transition metal oxide) is 0.2 or higher and 0.6 or lower, especially 0.3 or higher and 0.5 or lower, a positive electrode active material having excellent performance is likely to be obtained. The molar ratio between the electrophile contained in the reducing solution and the Li ions (electrophile/Li ions) is not particularly limited and may be, for example, 0.5 or higher and 2.0 or lower, 0.7 or higher and 1.5 or lower, or 0.9 or higher and 1.1 or lower.

In step S3, for example, simply bringing the Li-containing transition metal oxide into contact with the above-described reducing solution can additionally dope the Li-containing transition metal oxide with Li. The form of contact between the reducing solution and the Li-containing transition metal oxide is not particularly limited. For example, the Li-containing transition metal oxide may be immersed in the reducing solution, or the reducing solution may be sprayed onto the Li-containing transition metal oxide. As far as the present inventor confirmed, the above-described electrode active material according to one embodiment can be manufactured by controlling the contact time and the contact temperature of the Li-containing transition metal oxide and the reducing solution in step S3. Specifically, the time for which the reducing solution is held in contact with the Li-containing transition metal oxide may be 10 minutes or longer and 120 minutes or shorter, and the temperature at which the reducing solution is held in contact with the Li-containing transition metal oxide may be 10° C. or higher and 50° C. or lower. “Contact time” is regarded as, for example, in the case where the Li-containing transition metal oxide is immersed in the reducing solution, equivalent to “immersion time” from when the Li-containing transition metal oxide is immersed into the reducing solution until it is pulled up, and in the case where the reducing solution is sprayed onto the Li-containing transition metal oxide, equivalent to “spraying time.” “Contact temperature” is “temperature of reducing solution” to be brought into contact with the Li-containing transition metal oxide.

In step S3, after the Li doping using the reducing solution, a washing step or a drying step may be performed as necessary. The washing step or the drying step can control the amount of impurities (the amount of impurities attributable to the reducing solution) contained in the electrode active material.

### 3. Battery

A battery according to one embodiment has the above-described electrode active material of the disclosure. The electrode active material of the disclosure can be adopted, for example, as a positive electrode active material of a lithium-ion battery. As shown in FIG. 2, a battery 100 according to one embodiment has a positive electrode active material layer 10, an electrolyte layer 20, and a negative electrode active material layer 30. In the battery 100, for example, the positive electrode active material layer 10 may include the electrode active material of the disclosure. The battery 100 can include a positive electrode current collector 40 and a negative electrode current collector 50. The battery 100 may be a solid-state battery or may be an aqueous battery. A solid-state battery refers to a battery containing a solid electrolyte, and the presence of a liquid is acceptable. The battery 100 may be an all-solid-state battery that contains virtually no liquid. The composition of the battery may be the same as a conventional one except that the electrode active material of the disclosure is adopted. Detailed description is omitted here.

While one embodiment of the electrode active material etc. of the disclosure has been described above, various changes from the above-described embodiment can be made to the electrode active material etc. of the disclosure within such a range that no departure is made from the gist of the disclosure. In the following, the technology of the disclosure will be described in further detail while showing an example of implementation, but the technology of the disclosure is not limited to the following example of implementation.

### 1. Production of Electrode Active Material

### 1.1 Coprecipitation Synthesis of Transition Metal Source

MnSO₄·5H₂O, NiSO₄·6H₂O, and CoSO₄·7H₂O were weighed to a target composition ratio and dissolved in distilled water to a concentration of 1.2 mol/L to obtain a first liquid. In a separate container, Na₂CO₃ was dissolved in distilled water to a concentration of 1.2 mol/L to obtain a second liquid. Subsequently, to a reaction container with 1000 mL of pure water put therein beforehand, 500 mL each of the aforementioned first liquid and second liquid was dripped at a rate of about 4 mL/min. After the dripping was completed, stirring was performed at room temperature, at a stirring speed of 150 rpm, for one hour. The precipitate was washed with pure water and separated into a solid and a liquid by a centrifugal separator. The obtained precipitate was dried overnight at 120° C. and pulverized in a mortar, and then fine particles were removed by airflow classification. Thus, mixed salt particles (transition metal source) containing Mn, Ni, and Co were obtained.

### 1.2 Mixing of Transition Metal Source and Na Source (Na Coating)

Na₂CO₃ and distilled water were weighed to a concentration of 1150 g/L and then stirred using a stirrer until the former is completely dissolved to produce an Na₂CO₃ aqueous solution. The aforementioned mixed salt particles were mixed into the Na₂CO₃ aqueous solution to turn it into slurry. The Na₂CO₃ and the aforementioned mixed salt particles were mixed together so as to have a composition of Na_{0.7}Mn_{0.5}Ni_{0.2}Co_{0.3}O₂ after drying. The obtained slurry was dried by spray drying. Specifically, using a spray dry device DL 410, surfaces of the aforementioned mixed salt particles were coated with Na₂CO₃ under the conditions of a slurry feed rate of 30 mL/min, an inlet temperature of 200° C., a circulation air flow rate of 0.8 m³/min, and a spraying air pressure of 0.3 M Pa to obtain precursor particles.

### 1.3 Firing of Precursor Particles

In an ambient air atmosphere (humidity 50% or higher), using an alumina crucible, firing of the precursor particles was performed inside an electric furnace. Specifically, the precursor particles were subjected to “first temperature raising step,” “preliminary firing step,” “second temperature raising step,” “main firing step,” and “in-furnace cooling step” as shown in Table 1 below, and thereafter the fired product was taken out of the electric furnace at 250° C. and pulverized in a mortar in a dry atmosphere with a dew point of −30° C. or lower to obtain an Na-containing transition metal oxide (Na_{0.7}Mn_{0.5}Ni_{0.2}Co_{0.3}O₂) having the P2-type structure.

TABLE 1

| | Start | End | | Temperature |
|---|---|---|---|---|
| | temper- | temper- | | raising or |
| | ature | ature | Time | cooling speed |
| Step | (° C.) | (° C.) | (min) | (° C./min) |
| First temperature | 25 | 600 | 115 | 5 |
| raising step | | | | |
| Preliminary firing step | 600 | 600 | 360 | 0 |
| Second temperature | 600 | 900 | 100 | 3 |
| raising step | | | | |
| Main firing step | 900 | 900 | 60 | 0 |
| In-furnace cooling step | 900 | 250 | 130 | 5 |

### 1.4 Ion Exchange

LiNO₃ and LiCl were weighed to a molar ratio of 50:50, and were mixed with the aforementioned Na-containing transition metal oxide at such a molar ratio that the amount of Li became ten times the minimum required amount for ion exchange. Thus, a mixture was obtained. Subsequently, in an ambient air atmosphere (humidity 50% or higher), using an alumina crucible, firing was performed at 280° C. for one hour. Salt remaining after the firing was washed with pure water and separated into a solid and a liquid by vacuum filtration. The obtained precipitate was dried overnight at 120° C. to obtain an Li-containing transition metal oxide having an O2-type structure.

### 1.5 Li Doping

Inside a glovebox (Ar atmosphere), naphthalene was mixed and dissolved into tetrahydrofuran (THF) to a concentration of 1 mol/L to obtain a naphthalene solution. To this naphthalene solution, Li foil was further fed at the same molar ratio as the naphthalene, and the mixture was stirred for two hours to obtain a reducing solution containing Li ions at a ratio of 1 mol/L. The aforementioned Li-containing transition metal oxide was fed and immersed into the obtained reducing solution, and stirring was performed for the times and at the temperatures shown in Table 2 below. Here, the molar ratio between the Li ions contained in the reducing solution and the Li-containing transition metal oxide to be immersed in the reducing solution (Li ions/Li-containing transition metal oxide) was 0.4. After the stirring, the Li-containing transition metal oxide was washed with THF and separated into a solid and a liquid by vacuum filtration. The obtained precipitate was dried overnight at 120° C. to obtain electrode active materials (the aforementioned Li-containing transition metal oxides that were additionally doped with Li) respectively of Examples 1 to 3 and Comparative Examples 1 to 3.

TABLE 2

| | Contact time | Contact temperature |
|---|---|---|
| | (min) | (° C.) |
| Example 1 | 10 | 25 |
| Example 2 | 60 | 25 |
| Example 3 | 60 | 10 |
| Example 4 | 60 | 50 |
| Comparative Example 1 | 10 | 0 |
| Comparative Example 2 | 1 | 25 |
| Comparative Example 3 | 1 | −5 |

### 2. Determination of Chemical Composition of Electrode Active Material

The chemical compositions of the electrode active materials respectively of Examples 1 to 4 and Comparative Examples 1 to 3 were determined by an ICP analysis. Each of the electrode active materials according to Examples 1 to 4 and Comparative Examples 1 to 3 had a chemical composition represented by LiₓMn_{0.5}Ni_{0.2}Co_{0.3}O₂, i.e., had the same composition ratios of the transition metals, while differed in the composition ratio of Li. Table 3 below shows the composition ratios of Li (the value of X in the aforementioned chemical composition) of the electrode active materials respectively of Examples 1 to 4 and Comparative Examples 1 to 3.

### 3. Acquisition of X-Ray Diffraction Pattern of Electrode Active Material

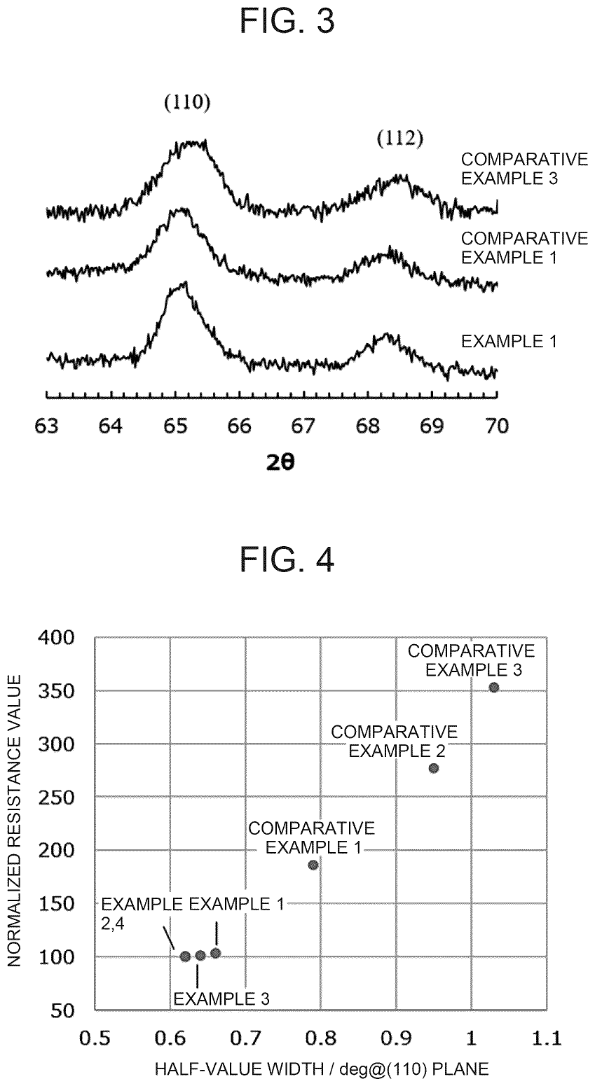

X-ray diffraction measurement was performed on the electrode active materials respectively of Examples 1 to 4 and Comparative Examples 1 to 3 to acquire X-ray diffraction patterns, and the crystal structures of the respective electrode active materials were determined. As a result, each electrode active material had the O2-type structure. In each X-ray diffraction pattern, the position of a peak top of an X-ray diffraction peak attributable to (110) plane of the O2-type structure was determined. A half-value width of this X-ray diffraction peak attributable to (110) plane of the O2-type structure was determined after the value of the background was subtracted. Table 3 below shows the positions of the peak tops and the half-value widths of the electrode active materials respectively of Examples 1 to 4 and Comparative Examples 1 to 3. FIG. 3 shows the X-ray diffraction patterns of the electrode active materials respectively of Example 1, Comparative Example 1, and Comparative Example 3.

### 4. Production and Evaluation of Coin Cell

Using the electrode active materials respectively of Examples 1 to 4 and Comparative Examples 1 to 3, coin cells (CR2032) were produced. The production procedure of the coin cell is as follows:
(1) The above-described electrode active material, acetylene black (AB) as a conduction aid, and polyvinylidenefluoride (PVdF) as a binder were weighed to a mass ratio of electrode active material:AB:PVdF=85:10:5 and dispersedly mixed into N-methyl-2-pyrrolidone to obtain a positive electrode composite material slurry. The positive electrode composite material slurry was applied to an aluminum foil and vacuum-dried overnight at 120° C. to obtain a positive electrode that was a laminate of a positive electrode active material layer and a positive electrode current collector.
(2) In a mixed solvent obtained by mixing trifluoropropylene carbonate (TFPC) and trifluoroethyl methyl carbonate (TFEMC) together at a ratio of TFPC:TFEMC=30 vol % 70 vol %, LiPF₆ was dissolved to a concentration of 1 M to obtain an electrolytic solution.
(3) As a negative electrode, a metal lithium foil was prepared.
(4) Using the positive electrode, the electrolytic solution, and the negative electrode, a coin cell (CR2032) was produced.

In a thermostatic bath held at 25° C., charging and discharging of the coin cell were performed in a voltage range of 2 to 4.8 V and at a 0.1C rate (1C=240 mA/g). Thereafter, in the thermostatic bath held at 25° C., a current equivalent to 3C was applied for 10 seconds in a state of SOC 50% to measure the DCIR. Using one of the coin cells respectively of Examples 1 to 4 and Comparative Examples 1 to 3 that had the lowest resistance value as a standard (100), the resistance values of the other coin cells were normalized. The result is shown in Table 3 below and FIG. 4.

### 5. Evaluation Result

TABLE 3

| | | Peak top | Half-value | Normalized |
|---|---|---|---|---|
| | Li composition | position | width | resistance |
| | ratio (X) | (°) | (°) | value |
| Example 1 | 0.97 | 65.14 | 0.66 | 103 |
| Example 2 | 0.98 | 65.04 | 0.62 | 100 |
| Example 3 | 0.99 | 64.96 | 0.64 | 101 |
| Example 4 | 0.98 | 65.08 | 0.62 | 100 |
| Comparative | 0.97 | 65.02 | 0.79 | 186 |
| Example 1 | | | | |
| Comparative | 0.96 | 65.24 | 0.95 | 277 |
| Example 2 | | | | |
| Comparative | 0.96 | 65.20 | 1.03 | 353 |
| Example 3 | | | | |

As shown in Table 3 and FIG. 3, those electrode active materials having the O2-type structure for which a diffraction peak attributable to the O2-type structure and having a peak top at 2θ=64.8° to 65.4° is recognized in the X-ray diffraction pattern of the electrode active material (Examples 1 to 4 and Comparative Examples 1 to 3) can be said to have high capacities owing to having been doped with Li. It is clear also from a previous application by the present applicant (Japanese Patent Application No. 2023-200071) that doping an O2-type Li-containing transition metal oxide after ion exchange additionally with Li increases the capacity of the electrode active material.

As shown in Table 3 and FIG. 4, it can be seen that those electrode active materials having the O2-type structure for which, in the X-ray diffraction pattern of the electrode active material, the half-value width of the diffraction peak among the diffraction peaks attributable to the O2-type structure that has a peak top at 2θ=64.8° to 65.4° is less than 0.79° (Examples 1 to 4) have lower resistance compared with Comparative Examples 1 to 3.

While the electrode active material having a specific chemical composition has been illustrated in the above-described example of implementation, the chemical composition of the electrode active material is not limited to the above-described one. It is considered that, as the peak top position and the half-value width described above are met, the electrode active material can have both a high capacity and low resistance regardless of the types of transition metals constituting the electrode active material.

What is claimed is:

1. An electrode active material having an O2-type structure, wherein, in an X-ray diffraction pattern of the electrode active material, a half-value width of a diffraction peak among diffraction peaks attributable to the O2-type structure that has a peak top at 2θ=64.8° to 65.4° is less than 0.79°.

2. The electrode active material according to claim 1, wherein the half-value width is 0.66° or less.

3. The electrode active material according to claim 1, wherein the electrode active material has a chemical composition represented by LiₐNa_{b}Mnₓ₋ₚNi_{y-q}CO_{z-r}M_{p+q+r}O₂ (where 0.70<a≤1.40, 0≤b≤0.20, x+y+z=1, 0≤p+q+r<0.17,and M is at least one type of element selected from B, Mg, Al, K, Ca, Ti, V, Cr, Fe, Cu, Zn, Ga, Ge, Sr, Y, Zr, Nb, Mo, and W).

4. A battery having the electrode active material according to claim 1.

5. A manufacturing method of an electrode active material, comprising:
obtaining an Na-containing transition metal oxide having a P2 structure;
exchanging at least some of Na of the Na-containing transition metal oxide with Li by ion exchange to obtain an Li-containing transition metal oxide having an O2-type structure; and
bringing a reducing solution containing Li ions into contact with the Li-containing transition metal oxide to dope the Li-containing transition metal oxide with Li, wherein:
a time for which the reducing solution is held in contact with the Li-containing transition metal oxide is one minute or longer and 120 minutes or shorter; and
a temperature at which the reducing solution is held in contact with the Li-containing transition metal oxide is 10° C. or higher and 50° C. or lower.
